(19) United States
(12) Patent Application Publication
(10) Pub. No.: US 2014/0011555 A1
(43) Pub. Date: Jan. 9, 2014

(54) INTERACTIVE STEP GAME FOR USE WITH A VIDEO GAME SYSTEM

(71) Applicant: Barbara McGhee, University City, MO (US)

(72) Inventor: Barbara McGhee, University City, MO (US)

(21) Appl. No.: 13/936,784

(22) Filed: Jul. 8, 2013

Related U.S. Application Data
(60) Provisional application No. 61/669,246, filed on Jul. 9, 2012.

(51) Int. Cl. A63F 13/00

(52) U.S. Cl. CPC A63F 13/00
USPC 463/7

(57) ABSTRACT

A computing device for presenting an interactive step game includes a processor, a memory, an output device, and an input device. The processor is programmed to identify a first step routine including a first plurality of target events associated with a body of a user and a second plurality of target events associated with one of a first dance accessory and a target audible sound. The processor presents, using the output device, the first step routine, and detects, by the input device, a first plurality of events generated by the body of the user, and a second plurality of events associated with one of the first dance accessory and an audible sound. The processor compares the first plurality of events with the first plurality of target events and the second plurality of events with the second plurality of target events to calculate a score.

### CROSS REFERENCE TO RELATED APPLICATIONS

This application claims the benefit of U.S. Provisional Patent Application Ser. No. 61/669,246, filed on Jul. 9, 2012 titled interactive step game for use with a video game system.

### BACKGROUND

The present disclosure relates generally to video games and, more particularly, to an interactive step game for use with a video game system.

Step dance is a style of dancing that exhibits footwork of the dancer. One known styles of step dancing is Irish step-dance, which has its roots in traditional Irish dance, and is marked by a rigidly held upper body during dance routines. Another known style of step dancing is “stepping”, or “step-dancing”. This style of step dance has its roots in African culture, and has been practiced competitively by African American fraternities and sororities. Step-dancing is a percussive dance in which the dancer uses his or her body to generate a performance including footwork, upper body gestures, and percussive sounds, and may integrate the use of dance accessories such as canes and rhythm sticks.

At least some known video games include computer software that is executed on a general purpose computer and/or on a dedicated video game console. Some known video game systems include at least one computer peripheral including, for example, a joystick, a controller, and/or a dance pad, which enables a user to play a video game on the video game system. Over time, video games have become increasingly interactive.

For example, at least some known dance video games include the use of a “step pad” to detect relative foot motion of a player/dancer. A pre-programmed “dance routine” is presented to the player/dancer during the course of play. The dance routine may include a visual representation of the step pad, along with some visual cues of which portions of the step pad that need to be pressed to perform the dance routine. The dance routine may include the playing of a song along with the presentation of the visual cues, assisting the player/dancer in synchronizing their movements to the music. Further, at least some known video game systems include a camera that enables the user to virtually interact with the video game systems by detecting the user's position and/or motion.

### BRIEF SUMMARY

In one aspect, a computing device for presenting an interactive step game is provided. The computing device includes a processor, a memory, an output device, and an input device. The computing device is programmed to present, using the output device, a step routine including a first target event associated with a body of a user, and a second target event associated with one of a dance accessory and a target audible sound. The computing device is also programmed to identify a first user event associated with the body of the user. The computing device is further programmed to identify a second user event associated with one of the dance accessory and a first user-generated audible sound. The computing device is also programmed to compare, using the processor, the first user event with the first target event and the second user event with the second target event to calculate a score.

In another aspect, a computer-implemented method for presenting an interactive step game is provided. The method is performed using at least one computing device including a processor, a memory, an output device, and an input device. The method includes presenting, using the output device, a step routine including a first target event associated with a body of a user, and a second target event associated with one of a dance accessory and a target audible sound. The method also includes identifying a first user event associated with the body of the user. The method further includes identifying a second user event associated with one of the dance accessory and a first user-generated audible sound. The method also includes comparing, using the processor, the first user event with the first target event and the second user event with the second target event to calculate a score.

In yet another embodiment, computer-readable storage media having computer-executable instructions embodied thereon are provided. When executed by a processor, the computer-executable instructions cause the processor to present a step routine including a first target event associated with a body of a user, and a second target event associated with one of a dance accessory and a target audible sound. The computer-executable instructions also cause the processor to identify a first user event associated with the body of the user. The computer-executable instructions further cause the processor to identify a second user event associated with one of the dance accessory and a first user-generated audible sound. The computer-executable instructions also cause the processor to compare the first user event with the first target event and the second user event with the second target event to calculate a score.

In yet another aspect, a computing device for presenting an interactive step game is provided. The computing device includes a processor, a memory, an output device, and an input device. The computing device is programmed to detect, by the input device, a first user event. The computing device is also programmed to generate a first step routine including a target event based at least in part on the first user event. The computing device is further programmed to present, using the output device, the first step routine. The computing device is also programmed to detect, by the input device, a second user event. The computing device is further programmed to compare the second user event with the target event to calculate a score.

In yet another aspect, a computer-implemented method for presenting an interactive step game is provided. The method is performed using at least one computing device including a processor, a memory, an output device, and an input device. The method includes detecting, by the input device, a first user event. The method also includes generating a first step routine including a target event based at least in part on the first user event. The method further includes presenting, using the output device, the first step routine. The method also includes detecting, by the input device, a second user event. The method further includes comparing the second user event with the target event to calculate a score.

In yet another aspect, computer-readable storage media having computer-executable instructions embodied thereon are provided. When executed by a processor, the computer-executable instructions cause the processor to detect a first user event. The computer-executable instructions also cause the processor to generate a first step routine including a target event based at least in part on the first user event. The computer-executable instructions further cause the processor to present the first step routine. The computer-executable instructions also cause the processor to detect a second user event. The computer-executable instructions further cause the processor to compare the second user event with the target event to calculate a score.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIGS. 1-5 show exemplary embodiments of the methods and systems described herein.

FIG. 1 is a schematic illustration of an exemplary environment for playing an exemplary interactive step game.

FIGS. 2-4 are flowcharts of exemplary methods that may be implemented in the environment shown in FIG. 1.

FIG. 5 is a schematic illustration of an exemplary computing device for presenting an interactive step game in accordance with one embodiment of the present disclosure.

Although specific features of various embodiments may be shown in some drawings and not in others, this is for convenience only. Any feature of any drawing may be referenced and/or claimed in combination with any feature of any other drawing.

### DETAILED DESCRIPTION

The present disclosure relates generally to video games and, more particularly, to an interactive step game for use with a video game system. In one embodiment, a computing device presents, to a user of the step game, a step routine that includes target events that the user emulates during play. The target events include a first target event associated with the body of the user, and a second target event associated with a dance accessory controlled by the user and/or an audible sound generated by the user. The computing device identifies user events as the user attempts to emulate the target events. A first user event associated with the body of the user is identified. A second user event associated with the dance accessory and/or the audible sound is identified. The first user event is compared to the first target event, and the second user event is compared to the second target event, to calculate a score for the user.

The methods and systems described herein may be implemented using computer programming or engineering techniques including computer software, firmware, hardware or any combination or subset thereof, wherein the technical effects may include at least one of: a) presenting, using an output device, a step routine including a first target event associated with a body of a user, and a second target event associated with one of a dance accessory and a target audible sound; b) identifying a first user event associated with the body of the user; c) identifying a second user event associated with one of the dance accessory and a first user-generated audible sound; d) comparing, using a processor, the first user event with the first target event and the second user event with the second target event to calculate a score; e) detecting, by the input device, a first user event; f) generating a first step routine including a target event based at least in part on the first user event; g) presenting, using the output device, the first step routine; h) detecting, by the input device, a second user event; and i)comparing the second user event with the target event to calculate a score.

As used herein, an element or step recited in the singular and proceeded with the word “a” or “an” should be understood as not excluding plural elements or steps unless such exclusion is explicitly recited. Moreover, references to “one embodiment” and/or the “exemplary embodiment” are not intended to be interpreted as excluding the existence of additional embodiments that also incorporate the recited features.

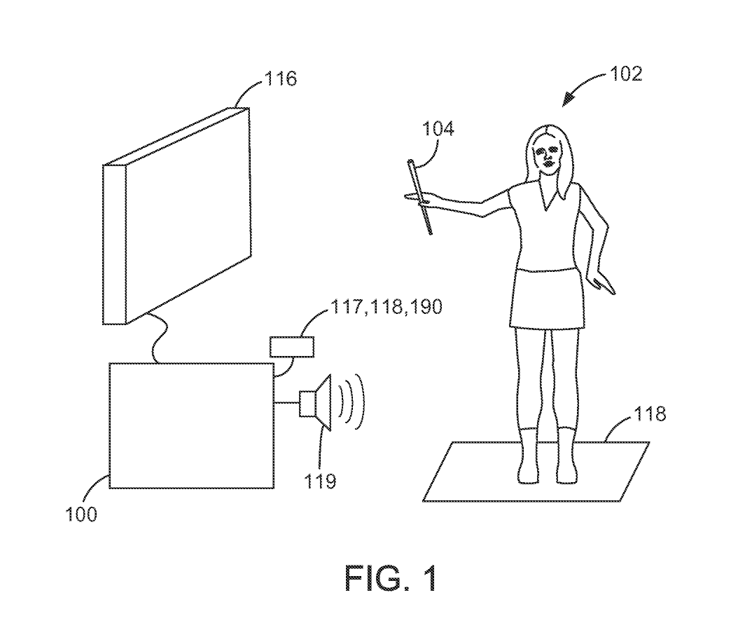

FIG. 1 is a diagram of a user 102 engaged with the presentation of an interactive step game using a computing device 100, such as a gaming console. As used herein, the terms “step”, “stepping”, “step-dancing”, and the like refer to any form of percussive dance in which any part of a person's body is used as an instrument to produce complex rhythms and sounds. For example, the rhythms and sounds may be produced through a mixture of footsteps, spoken word, and/or hand claps. Stepping draws from elements of gymnastics, break dance, tap dance, march, military formations, African dance, Caribbean dance, and/or stunts. Some forms of stepping include the use of props including, without limitation, canes, rhythm sticks, fire, and/or blindfolds. As described below, stepping may be performed by an individual person or by groups of people.

It should be understood that while the example embodiments are described herein using the style of the “stepping” style of dance, the systems and methods described herein may be used in other styles of step dancing such as, for example, Irish step-dancing, tap dancing, clogging, military and drill-team movements, and break dancing.

In the example embodiment, computing device 100 is a gaming console or personal computer configured to execute a step dance game. User 102 is presented with aspects of the dance game through output devices communicatively coupled to computing device 100, such as a display device 116 and/or speakers 119. User 102 interacts with the dance game and computing device 100 through input devices communicatively coupled to computing device 100, such as a microphone 117, a camera 190, and/or other sensor devices 118. In some embodiments, user 102 manipulates one or more dance accessories 104 during participation in the game. Dance accessories 104 are implements, such as canes, hats, percussive sticks, or other implements that, generally, are not fixed to the user's person, and may be used for theatrical effects during a step dance performance.

During operation, in the exemplary embodiment, computing device 100 executes and presents a step game to user 102. The step game receives a signal associated with a selection of a user avatar, an organization, and/or a predetermined step routine. More specifically, the user avatar, the organization, and/or the step routine are presented on display device 116, the user uses an input interface (not shown) to select the user avatar, the organization, and/or the step routine, and the selection is received by computing device 100 from the user input interface.

As used herein, the term “user avatar” and the like refer to any virtual object that represents the user. As used herein, the term “organization” and the like refer to any group or team that the user is affiliated with. For example, organizations may include, without limitation, colleges, universities, fraternities, sororities, churches, and/or club teams. Accordingly, the user may input alphanumeric characters, colors, etc. that may be used to identify the organization. The alphanumeric characters may include letters and/or script from any writing system including, without limitation, Arabic, Aramaic, Baybayin, Bengali, Canadian Aboriginal Syllabics, Chinese, Cuneiform, Cyrillic, Greek, Gujarati, Devanagari, Ge'ez, Georgian, Hebrew, Kannada, Korean, Lao, Latin, Lontara, Malayalam, Oriya, Syriac, Tibetan, and/or Tifinagh. As used herein, the term “step routine” and the like refer to any choreographed position and/or motion. In at least some embodiments, music, rhythmic beats, and/or other audio are associated with the step routine. In other embodiments, music, rhythmic beats, and/or other audio may be selected by computing device 100 and/or the user for use with the step routine.

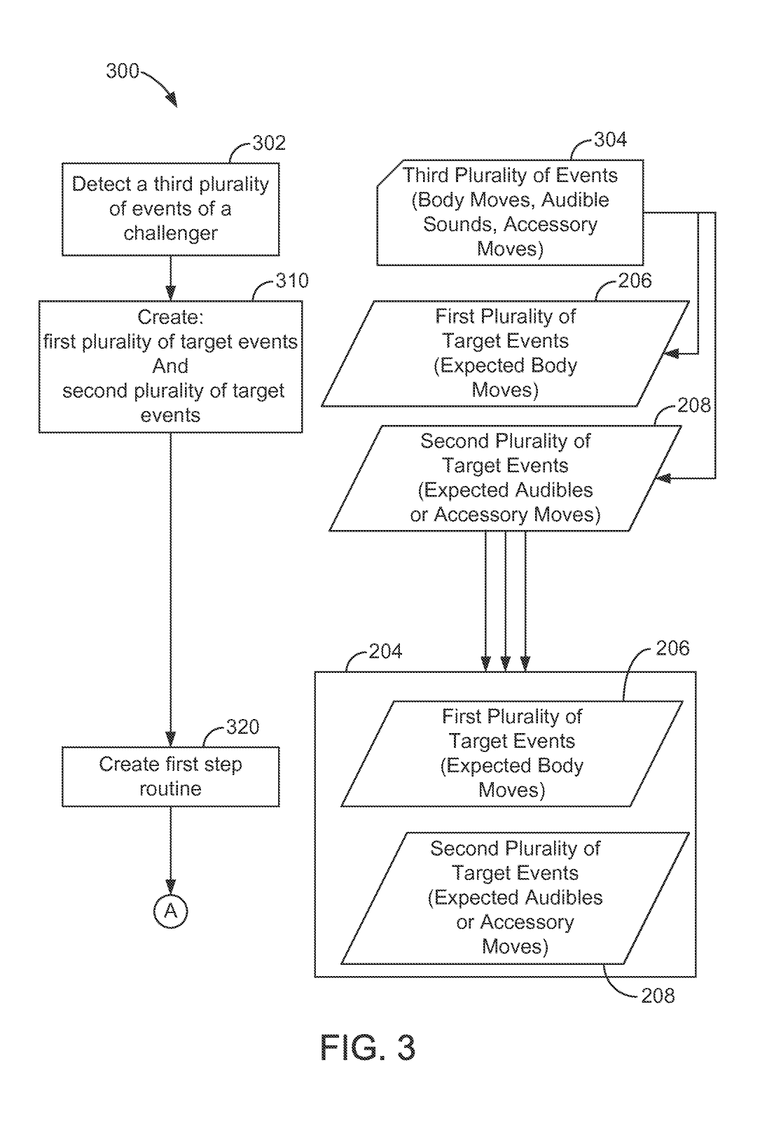

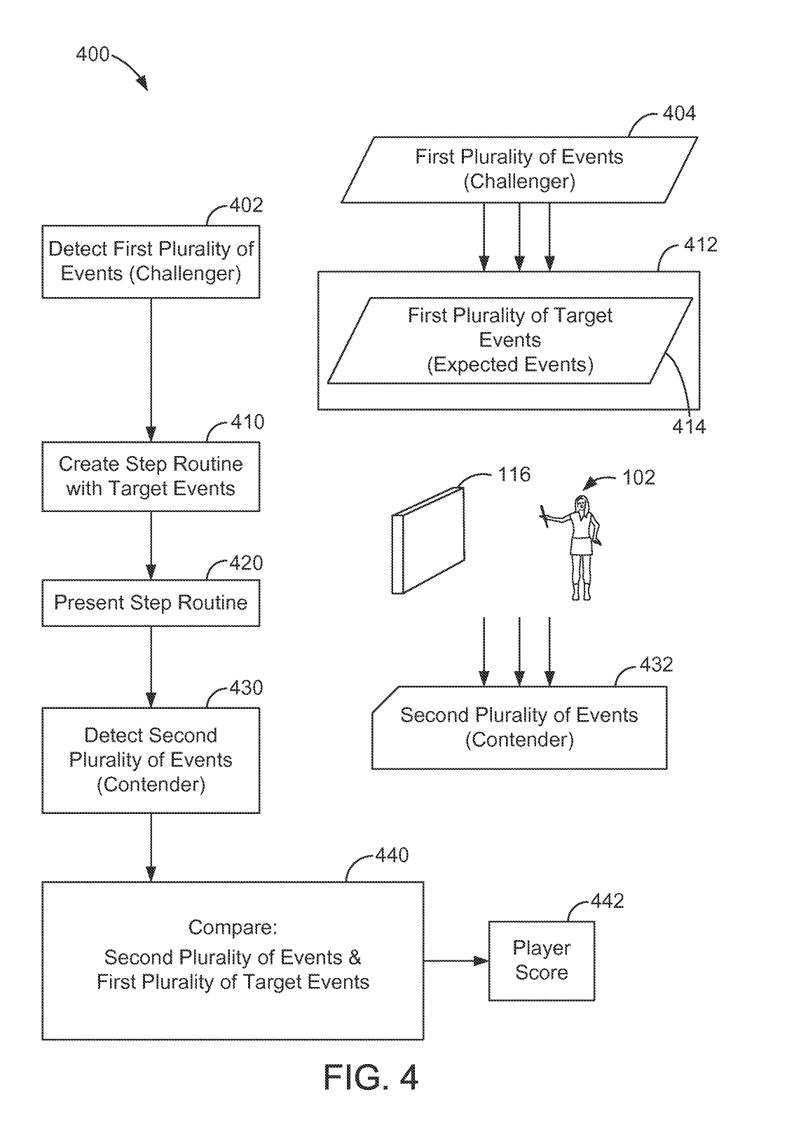

In some embodiments, a step routine is identified by user 102. The term “step routine”, as used herein, refers to either the real-life series of actions of a dancer made during a particular step dance, or to come computer representation of the series of actions. In some embodiments, the dance game will have a plurality of step routines stored in memory of computing device 100, or on non-transitory computer media such as a CD-ROM. During game play, a particular step routine may be selected from the plurality of stored step routines. In other embodiments, the first step routine is created by the actions of a challenging player, discussed in greater detail below with reference to FIGS. 3 and 4.

The step routine includes a series of “target events” that are designed to be emulated by the user/player of the game, such as user 102. The term “target event”, as used herein, generally refers to an event or action that is expected from the user/player. Each of the “target events”, in the exemplary embodiment, include an accompanying visual and/or audio output that assists the user in knowing what action is expected by the game at a particular point during the step routine. Generally speaking, the dance game presents a series of “target events” to the players, and the players respond with a series of “user events” or actions. The term “user event”, as used herein, generally refers to an action that is sensed from the actions of the user while participating in the game. The user events are identified and/or sensed using one or more input devices, such sensors 118, microphone 117, and/or camera 190. In some embodiments, the events are performed by the user as the target events are presented to the user.

In the example embodiment, target events are associated with one or more of the body of the user, an audible sound generated by the user, and a dance accessory controlled by the user. In some embodiments, a sensor 118, such as a step pad, or a camera device 190 may be used to sense user events associated with the position or motion of the body of user 102. For example, a target event may expect user 102 to move his left foot to a certain position, and may receive a signal from camera device 190 or the step pad sensor 118 that the user has accomplished the event. Further, in some embodiments, a microphone 117 may be used to sense events associated with audible sounds generated by the user. For example, a target event may expect the user to clap, and may receive a signal from microphone 117 that user 102 has accomplished the event. Audible sounds may be generated by user 102 using, for example, a hand or hands, such as through clapping or slapping, a leg of the user, such as through slapping the leg, a foot of the user, such as through stomping or tapping, vocally by the user, and may include either verbal or non-verbal sounds, and through dance accessories, such as tapping a cane. In some embodiments, the user may wear a positional sensor 118 and/or a microphone 117 device on their person, such as an ankle or foot device to facilitate sensing of body position and/or sound.

Also, in some embodiments, sensor 118 may be used to sense events associated with the position or motion of dance accessories 104. Dance accessory 104 may include attachments that facilitate positional sensing of accessory 104 by sensor 118. For example, a target event may expect a cane to be controlled by user 102 during a step routine, and spun in a circle, and may receive a signal from sensor 118 that user 102 has accomplished the event. Moreover, in some embodiments, a target event may include multiple expected events, perhaps of different types. For example, a target event may expect a cane to be tapped synchronously with a foot of user 102, and may receive a signal from microphone 117 identifying the tap of the cane, and a signal from camera device 190 regarding the position of the foot of user 102.

In the exemplary embodiment, computing device 100 presents the step routine to the user. More specifically, the user attempts to mimic and/or copy the step routine presented on display device 116 and/or speaker 119. For example, in one embodiment, a cue of movements and/or positions scrolls down and/or across a screen, and the user attempts to perform the movement and/or position when the cue crosses an active box. Additionally or alternatively, the user avatar presented on display device 116 performs the step routine, and the user attempts to perform the movement and/or position of the user avatar. Presenting the step routine to user 102, in some embodiments, involves outputting a song associated with the step routine, along with the visual and/or audio output associated with the target events of the step routine in a particular sequence and timing. In some embodiments, the particular sequence and timing of the target events are closely coupled with the song associated with the step routine.

In the exemplary embodiment, while the step routine is being presented to the user, the user is performing events along with the step routine. During the presentation, computing device 100 receives user's events via input from input devices such as microphone 117, sensor 118, and camera 190, as described above. More specifically, computing device 100 is detecting events associated with a body of user 102, events associated with an audible sound generated by user 102, and/or events associated with a position or motion of dance accessory 104, as described above in reference to target events. In some embodiments, each event input includes an associated timing of when it was received, which may be used during comparison to the target events for purposes of scoring. In at least some embodiments, the user copies the step routine on a hard surface that enables sounds to be produced.

In the exemplary embodiment, a comparison of the user's performance, i.e., user's 102 events, is executed by computing device 100. More specifically, computing device 100 compares body movement user events to the body movement target events of the step routine, audible sound user events to the audible sound target events of the step routine, and accessory movement user events to the accessory movement target events of the step routine. In some embodiments, computing device 100 calculates a score contemporaneously with the performance. In at least some embodiments, computing device 100 provides real-time feedback by presenting the score and/or providing audible feedback (e.g., cheering, booing). Computing device 100 calculates the score based on, without limitation, the motion, position, yelling, sounds, timing, and/or sense of rhythm of the user with respect to the step routine. Accordingly, the closer the user is able to mimic and/or copy the step routine, the higher the score. Conversely, the score is lower when the user is not able to closely mimic and/or copy the step routine. In some embodiments, computing device 100 attempts to pair user events with one or more target events. A score is calculated based on the comparison. In some embodiments, the score and comparison is based on timing associated with user events as compared with an expected timing of the paired target event. Alternatively, the score may be calculated using any algorithm that enables computing device 100 to function as described herein.

In other exemplary embodiments, multiple users 102 participate in the dance game. During operation, in the exemplary embodiment, computing device 100 receives a signal associated with a request to play a multi-player game. More specifically, computing device 100 receives a first signal associated with a request to start a game and a second signal associated with a request to join the game. In the exemplary embodiment, the first signal and the second signal are received from a first computing device 100 and a second computing device (not shown) similar to computing device 100, respectively, and the second computing device may be remotely located relative to first computing device 100. Alternatively, the request to play a multi-player game may be received from a common computing device 100 and/or input interface. Any number of players may transmit the second signal from any number of computing devices 100 to join the game.

In the exemplary multi-player embodiment, computing device 100 receives a signal associated with a selection of a predetermined step routine. More specifically, a first user may select the step routine on the first computing device and/or a second user may select the step routine on the second computing device, and the selection is received by computing device from the first computing device and/or the second computing device.

In the exemplary embodiment, computing device 100 presents the step routine to the first user and/or the second user. More specifically, the first computing device presents the step routine to the first user, and the second computing device presents the step routine to the second user. In the exemplary embodiment, a first input interface, such as sensor 118, camera 190, and/or microphone 117, detects events of the first user, and a second input interface (not shown) detects events of the second user. Alternatively, the step routine may be presented to the first user and/or the second user on a common computing device 100 and/or display device 116, and/or events of the first user and/or the second user may be detected on a common computing device 100 and/or the input interface. In such embodiments, the first user and the second user may step or play simultaneously or, alternatively, the first user and the second user may step or play one at a time. In the exemplary embodiment, computing device 100 compares the events of the first user and/or the second user with the target events of the step routine to calculate at least one score associated with the first user and/or the second user, and compares the scores to determine a winner.

In still other multi-player embodiments, computing device 100 receives a signal associated with a request to play a multi-player game. More specifically, computing device 100 receives a first signal associated with a request to start a game and a second signal associated with a request to join the game. In the exemplary embodiment, the first signal and the second signal are received from a first computing device 100 and a second computing device (not shown) similar to computing device 100, respectively. Alternatively, the request to play a multi-player game may be received from a common computing device 100 and/or input interface. Any number of players may transmit the second signal from any number of computing devices 100 to join the game.

In the exemplary embodiment, computing device 100 receives a signal associated with an event of a “challenger.” The challenger is a user of the multi-player game, such as first user or second user, that creates a step routine that will be presented to a “contender”, i.e., another user of the multi-player game. The contender will then attempt to mimic the challenger's step routine during game play. More specifically, a challenger input interface (not shown) detects events of the challenger, and computing device 100 generates a step routine, including a series of target events, based on the detected events of the challenger. In the exemplary embodiment, the challenger may be the first user and/or the second user. Accordingly, the challenger input interface may be communicatively coupled to the first computing device and/or the second computing device.

In the exemplary embodiment, computing device 100 presents the generated step routine to the contender. More specifically, a contender display device (not shown) presents the step routine to the contender, and a contender input interface (not shown) detects events of the contender. In the exemplary embodiment, computing device 100 compares the events of the contender with the step routine to calculate a score associated with the challenger and/or the contender. That is, the events of the contender is compared with the target events of the step routine created by the challenger. In the exemplary embodiment, the challenger and the contender are cooperating on a common team. Accordingly, the closer the contender is able to mimic and/or copy the challenger, the higher the score. Conversely, the score is lower when the contender is not able to closely mimic and/or copy the challenger. Alternatively, the challenger and the contender may compete against each other. In the exemplary embodiment, the contender may be the first user and/or the second user. That is, in at least some embodiments, a single player may step and/or play as both the challenger and the contender.

In some embodiments, computing device 100 may detect events of a plurality of users, sometimes a group of three or more, and analyze the events for uniform and/or synchronized movement and/or positioning. In at least some embodiments, computing device 100 may detect the plurality of users simultaneously. In some embodiments, the events of the challenger and/or the contender may include body position and/or movement events, audible events created by the user, and/or dance accessory position and/or movement events.

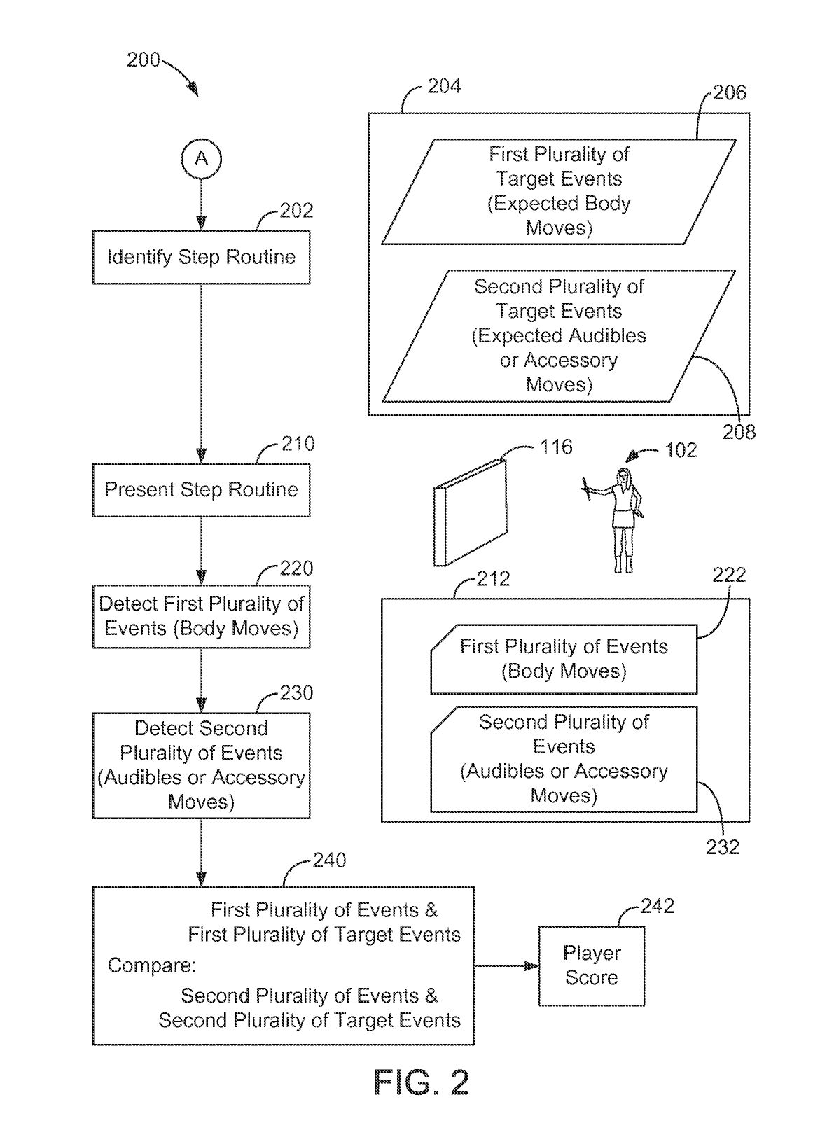

FIG. 2 is a flowchart of an exemplary method 200 that may be implemented in the environment shown in FIG. 1. A first step routine 204 for the dance game includes a series of “target events” 206 and 208 that are designed to be emulated by the user/player of the game. In the example embodiment, target events 206 and 208 are associated with the body of the user, an audible sound generated by the user, and/or a dance accessory controlled by the user. In some embodiments, the first step routine 204 is selected by a user of the computing device from a plurality of pre-determined step routines 204 stored in memory of computing device 100, or on non-transitory computer media such as a CD-ROM. In other embodiments, the first step routine is created by the actions of a user/player, discussed in greater detail below with reference to FIGS. 3 and 4.

In the exemplary embodiment, step routine 204 is presented 210 to user 102. In the exemplary embodiment, step routine 204 is presented to user 102 using display device 116 (shown in FIG. 1). Presenting 210, in some embodiments, involves outputting a song associated with step routine 204, along with the visual and/or audio output associated with target events 206 and 208 in a particular sequence and timing In some embodiments, the particular sequence and timing of target events 206 and 208 are closely coupled with the song associated with step routine 204.

In the exemplary embodiment, while step routine 204 is being presented 210, user 102 is performing user events 212 along with the presentation. During the presentation 210, computing device 100 receives input from input devices that detect user events 212. More specifically, computing device 100 is identifying 220 a first user event 222 and identifying 230 a second user event 232. First user event 222 is an event associated with a body of the user, as described above in reference to target events. Second user event 232 is an event associated with an audible sound generated by the user and/or a position or motion of a dance accessory 104 (shown in FIG. 1), as described above in reference to target events. In some embodiments, computing device 100 is identifying a plurality of user events 206 and/or 208. Further, in some embodiments, detecting 220 and detecting 230 occur contemporaneously, with each event including an associated timing of when it was received.

In the exemplary embodiment, while events 212 are being generated by the performing user 102, a comparison 240 of user's 102 events 212 is executed by computing device 100. More specifically, computing device 100 compares 240 first user event 222 to first target event 206, and second user event 232 to second target event 208. Events in first user events 222 and second user events 232 are paired with one or more target events 206 and 208. A score 242 is calculated based on the comparison. In some embodiments, score 242 and comparison 240 is based on timing associated with user events 222 and 232 as compared with an expected timing of the paired target event.

FIG. 3 is a flowchart of an exemplary method 300 that may be implemented in the environment shown in FIG. 1. In some embodiments, the same user 102 (shown in FIG. 2) or a second user (not shown) may be involved in identifying the step routine 204 to be performed by user 102. More specifically, identifying step routine 204 may include generating first step routine 204 using the actions of the second user, referred to in this embodiment as the “challenger.” In some embodiments, the “challenger” creates a routine by his own actions using computing device 100 or other similar computing device, which is then presented to user 102, in this embodiment referred to as the “contender.”

Generating first step routine 204, in the example embodiment, involves first identifying 302, by the computing device 100 or another computing device, user events of a challenger. More specifically, computing device 100 identifies a third user event 304 of the challenger associated with body movement and/or position of the challenger's body, and a fourth user event 306 associated with one of an audible sound or position or movement of a dance accessory. First target event 206 is generated 320 based on third user event 304, and second target event 208 is generated based on fourth user event 306. Thus, step dance 204 is generated, and may be subsequently performed by user 102 as shown in FIG. 2. In some embodiments, a plurality of events of the challenger 304 identified 302 and 310, and converted to target events 206 and 208. In operation, in reference to FIG. 2, when first step routine 204 is then presented 210 to user 102 as the “contender,” then user 102 effectively must mimic the moves created by the challenger. Subsequently, the user's 102 score 242 is based upon how well he or she performed the challenger's routine.

FIG. 4 is a flowchart of an exemplary method 400 that may be implemented in the environment shown in FIG. 1. In some embodiments, such as during multi-player play, computing device 100 detects 402 a first user event 404 generated by a challenger, as discussed above. Computing device 100 then creates 410 a step routine 412 based at least in part on the challenger's first user event 404. Step routine 412 includes at least first target event 414, which may be one or more of body movement or positional events associated with the body of a user, audible events generated by a user, and/or positional and/or movement events associated with a dance accessory controlled by a user. In some embodiments, the challenger generates a plurality of first user events 404, which become a plurality of target events 414.

In the exemplary embodiment, step routine 412 is then presented 420 to a contender, such as user 102. Computing device detects 430 a second plurality of events 432 of the contender while contender participates in the game. Computing device 100 compares 440 second plurality of events 432, i.e., the contender's actions, to first plurality of target events 414 of step routine 412, i.e., the step routine generated by the challenger. Computing device 100 generates a score 442 based at least in part on the comparison 440.

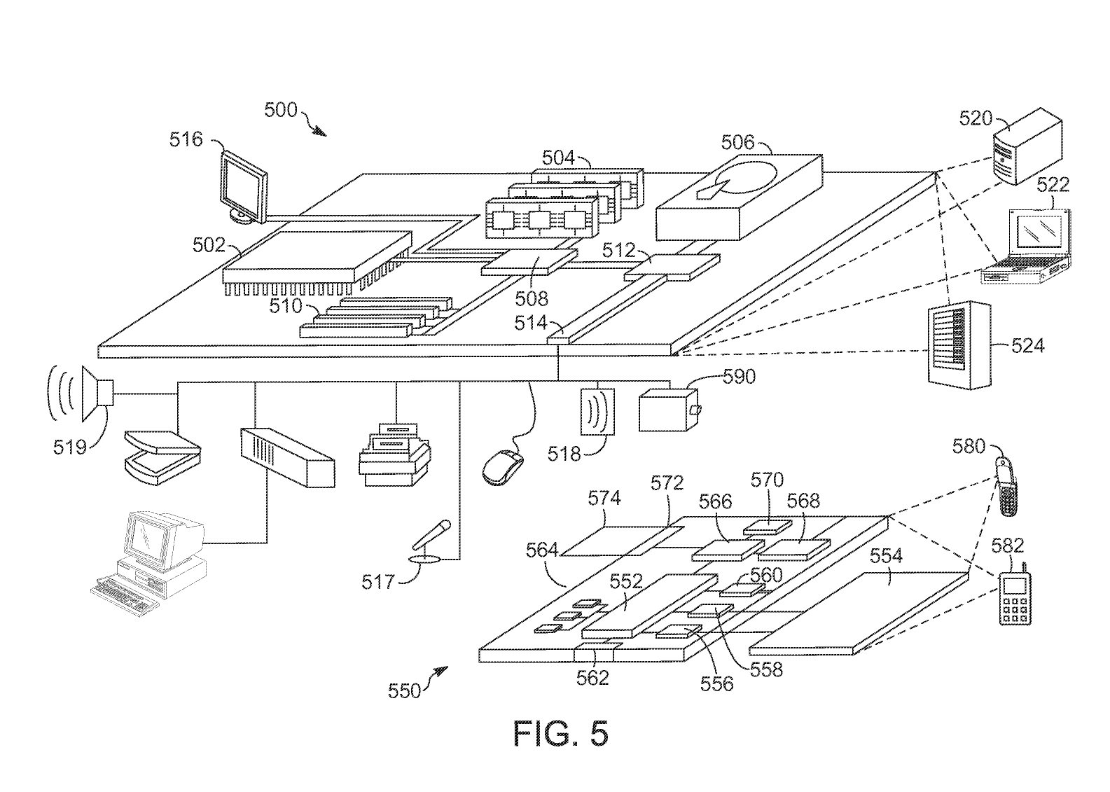

FIG. 5 is a schematic illustration of an exemplary computing device 500 and 550 for presenting an interactive step game in accordance with one embodiment of the present disclosure. In some embodiments, computing device 500 and 550 is a gaming console or personal computer configured with a step dancing game. Further, in some embodiments, computing device 500 and/or 550 may be used as computing device 100 (shown in FIG. 1).

Computing device 500 is intended to represent various forms of digital computers, such as laptops, desktops, workstations, personal digital assistants, servers, blade servers, mainframes, and other appropriate computers such as computer gaming devices. Computing device 550 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the disclosures described and/or claimed in this document.

The computing device 500 includes a processor 502, memory 504, a storage device 506, a high-speed interface or controller 508 connecting to memory 504 and high-speed expansion ports 510, and a low-speed interface or controller 512 connecting to low-speed bus 514 and storage device 506. Each of the components 502, 504, 506, 508, 510, and 512, are interconnected using various buses, and may be mounted on a common motherboard or in other manners as appropriate. The processor 502 can process instructions for execution within the computing device 500, including instructions stored in the memory 504 or on the storage device 506 to display graphical information for a Graphical User Interface (“GUI”) on an external input/output device, such as display 516 coupled to high-speed controller 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. In another implementation, storage may be provided by a “cloud” service, such that some data is stored remote from storage device 506 and computing devices 500, 550. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high-speed controller 508 manages bandwidth-intensive operations for the computing device 500, while the low-speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed bus 514. The low-speed bus 514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

In the example embodiment, device 500 includes a speaker 519 for providing audio output to a user. Further, device 500 also includes a microphone 517 for receiving audio input from a user, and a camera 590 for receiving video input from a user. Device 500 also includes a sensor 518 for receiving input data, including at least positional data associated with the user during participation in the dance game. In some embodiments, sensor 518 is a “step pad” having a plurality of buttons, and is configured to sit on the floor and be danced on by a user during participation in a dance game. In other embodiments, sensor 518 is an infra-red (IR) or radio frequency (RF) sensor. In still other embodiments, sensor 518 is configured to input positional data associated with dance accessories. Alternatively, any sensor 518 that enables the systems and methods as described herein may be used.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, 568, and 590 are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and user interface 556 coupled to a display 554. The display 554 may be, for example, a TFT LCD (Thin-Film-Transistor Liquid Crystal Display) or an OLED (Organic Light Emitting Diode) display, or other appropriate display technology. The user interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may also include secure information. Thus, for example, expansion memory 574 may be provided as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, Wi-Fi, or other such transceiver (not shown). In addition, GPS (Global Positioning system) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

Device 500, 550 includes a digital camera 590. The digital camera 590 may capture real-world images in either still-image or full-motion video. The digital camera 590 may store images or video in memory 564 or expansion memory 574. The digital camera 590 may also display images or video directly to user interface 556. Captured images or video may be accessed by processor 552 for image processing.

The computing device 550 may be implemented in a number of different forms, as shown in the figure. For example, it may be implemented as a cellular telephone 580. It may also be implemented as part of a smart phone 582, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

To provide for interaction with a user, the systems and techniques described here can be implemented on a computer having a display device 116 (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing device (e.g., computing device 500 and/or 550) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

Computing device 500 can include clients and servers. A client and server are generally remote from each other and typically interact through a communication network. The relationship of client and server arises by virtue of computer programs running on the respective computers and having a client-server relationship to each other.

In the example embodiment, a dance game may be stored on the computing device 500. Computing device 500 is configured to process the dance game, receive data inputted by a user, interact with the user through various input devices, such as microphone 117, sensors 118, and camera 190, and output devices, such as display device 116 and speakers 119, execute functionality included within the dance game, and execute the dance experiences associated with the dance game.

As illustrated in FIG. 5, computing devices 500 and 550 are configured to receive and/or retrieve electronic documents from various other computing devices connected to computing devices 500 and 550 through a communication network, and store these electronic documents within at least one of memory 504, storage device 506, and memory 564. Computing devices 500 and 550 are further configured to manage and organize these electronic documents within at least one of memory 504, storage device 506, and memory 564 using the techniques described herein. Such electronic documents may include, for example, step routines associated with a step dance game. These electronic documents may be stored on “cloud” storage (i.e., remote from computing device 500, 550).

Exemplary embodiments of an interactive step game for use with a video game system are described above in detail. The methods and systems are not limited to the specific embodiments described herein, but rather, components of systems and/or steps of the method may be utilized independently and separately from other components and/or steps described herein. Each method step and each component may also be used in combination with other method steps and/or components. Although specific features of various embodiments may be shown in some drawings and not in others, this is for convenience only. Any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing device for presenting an interactive step game, the computing device comprising a processor, a memory, an output device, and an input device, wherein the computing device is programmed to:
present, using the output device, a step routine including a first target event associated with a body of a user, and a second target event associated with one of a dance accessory and a target audible sound;
identify a first user event associated with the body of the user;
identify a second user event associated with one of the dance accessory and a first user-generated audible sound; and
compare, using the processor, the first user event with the first target event and the second user event with the second target event to calculate a score.

2. The computing device in accordance with claim 1, wherein the computing device is further programmed to identify the first user event by detecting a position of the body of the user, and identify the second user event by detecting one of a position of the dance accessory, and the first user-generated audible sound.

3. The computing device in accordance with claim 1, wherein the computing device is further programmed to:
identify whether the target audible sound is associated with at least one of a hand of the user, a foot of the user, vocals of the user, and the dance accessory; and
determine whether the first user-generated audible sound is associated with the at least one of the hand of the user, the foot of the user, vocals of the user, and the dance accessory.

4. The computing device in accordance with claim 1, wherein the computing device is further programmed to:
detect a third user event associated with the body of the user;
detect a fourth user event associated with one of the dance accessory and a second user-generated audible sound;
generate the first target event based at least in part on the third user event; and
generate the second target event based at least in part on the fourth user event.

5. A computer-implemented method for presenting an interactive step game, the method is performed using at least one computing device including a processor, a memory, an output device, and an input device, said method comprising:
presenting, using the output device, a step routine including a first target event associated with a body of a user, and a second target event associated with one of a dance accessory and a target audible sound;
identifying a first user event associated with the body of the user;
identifying a second user event associated with one of the dance accessory and a first user-generated audible sound; and
comparing, using the processor, the first user event with the first target event and the second user event with the second target event to calculate a score.

6. The method in accordance with claim 5, wherein the first user event is identified by detecting a position of the body of the user, and the second user event is identified by detecting one of a position of the dance accessory, and the first user-generated audible sound.

7. The method in accordance with claim 5 further comprising:
identifying whether the target audible sound is associated with at least one of a hand of the user, a foot of the user, vocals of the user, and the dance accessory; and
determining whether the first user-generated audible sound is associated with the at least one of the hand of the user, the foot of the user, vocals of the user, and the dance accessory.

8. The method in accordance with claim 5 further comprising:
detecting a third user event associated with the body of the user;
detecting a fourth user event associated with one of the dance accessory and a second user-generated audible sound;
generating the first target event based at least in part on the third user event; and
generating the second target event based at least in part on the fourth user event.

9. Computer-readable storage media having computer-executable instructions embodied thereon, wherein, when executed by a processor, the computer-executable instructions cause the processor to:
present a step routine including a first target event associated with a body of a user, and a second target event associated with one of a dance accessory and a target audible sound;
identify a first user event associated with the body of the user;
identify a second user event associated with one of the dance accessory and a first user-generated audible sound; and
compare the first user event with the first target event and the second user event with the second target event to calculate a score.

10. The computer-readable storage media in accordance with claim 9, wherein the computer-executable instructions further cause the processor to identify the first user event by detecting a position of the body of the user, and identify the second user event by detecting one of a position of the dance accessory, and the first user-generated audible sound.

11. The computer-readable storage media in accordance with claim 9, wherein the computer-executable instructions further cause the processor to:
identify whether the target audible sound is associated with at least one of a hand of the user, a foot of the user, vocals of the user, and the dance accessory; and
determine whether the first user-generated audible sound is associated with the at least one of the hand of the user, the foot of the user, vocals of the user, and the dance accessory.

12. The computer-readable storage media in accordance with claim 9, wherein the computer-executable instructions further cause the processor to:
detect a third user event associated with the body of the user;
detect a fourth user event associated with one of the dance accessory and a second user-generated audible sound;
generate the first target event based at least in part on the third user event; and
generate the second target event based at least in part on the fourth user event.

13. A computing device for presenting an interactive step game comprising a processor, a memory, an output device, and an input device, wherein the computing device is programmed to:
detect, by the input device, a first user event;
generate a first step routine including a target event based at least in part on the first user event;
present, using the output device, the first step routine;
detect, by the input device, a second user event; and
compare the second user event with the target event to calculate a score.

14. The computing device in accordance with claim 13, wherein the computing device is further programmed to detect the first user event by detecting a first position of a first body, and detect the second user event by detecting one of a second position of the first body and a first position of a second body.

15. The computing device in accordance with claim 13, wherein the computing device is further programmed to detect the first user event by detecting a first position of a first dance accessory, and detect the second user event by detecting one of a second position of the first dance accessory and a first position of a second dance accessory.

16. The computing device in accordance with claim 13, wherein the computing device is further programmed to detect the first user event by detecting a first user-generated sound, and detect the second user event by detecting a second user-generated sound.

17. A computer-implemented method for presenting an interactive step game, the method is performed using at least one computing device including a processor, a memory, an output device, and an input device, said method comprising:
detecting, by the input device, a first user event;
generating a first step routine including a target event based at least in part on the first user event;
presenting, using the output device, the first step routine;
detecting, by the input device, a second user event; and
comparing the second user event with the target event to calculate a score.

18. The method in accordance with claim 17, wherein the first user event is detected by detecting a first position of a first body, and the second user event is detected by detecting one of a second position of the first body and a first position of a second body.

19. The method in accordance with claim 17, wherein the first user event is detected by detecting a first position of a first dance accessory, and the second user event is detected by detecting one of a second position of the first dance accessory and a first position of a second dance accessory.

20. The method in accordance with claim 17, wherein the first user event is detected by detecting a first user-generated sound, and the second user event is detected by detecting a second user-generated sound.

21. Computer-readable storage media having computer-executable instructions embodied thereon, wherein, when executed by a processor, the computer-executable instructions cause the processor to:
detect a first user event;
generate a first step routine including a target event based at least in part on the first user event;
present the first step routine;
detect a second user event; and
compare the second user event with the target event to calculate a score.

22. The computer-readable storage media in accordance with claim 21, wherein the computer-executable instructions further cause the processor to detect the first user event by detecting a first position of a first body, and detect the second user event by detecting one of a second position of the first body and a first position of a second body.

23. The computer-readable storage media in accordance with claim 21, wherein the computer-executable instructions further cause the processor to detect the first user event by detecting a first position of a first dance accessory, and detect the second user event by detecting one of a second position of the first dance accessory and a first position of a second dance accessory.

24. The computer-readable storage media in accordance with claim 21, wherein the computer-executable instructions further cause the processor to detect the first user event by detecting a first user-generated sound, and detect the second user event by detecting a second user-generated sound.
